(19) United States
(12) Patent Application Publication
(10) Pub. No.: US 2024/0313921 A1
(43) Pub. Date: Sep. 19, 2024

(54) Antenna Transmit Diversity in Frequency Domain

(71) Applicant: Apple Inc., Cupertino, CA (US)

(72) Inventors: Lijie Zhang, Beijing (CN); Zhiwei Wang, Beijing (CN); Lakshmi N Kavuri, San Jose, CA (US)

(21) Appl. No.: 18/602,463

(22) Filed: Mar. 12, 2024

Related U.S. Application Data
(60) Provisional application No. 63/489,980, filed on Mar. 13, 2023.

(51) Int. Cl. H04L 5/00; H04W 72/0453; H04W 72/0457; H04W 72/231

(52) U.S. Cl. CPC H04L 5/0051; H04L 5/001; H04W 72/0453; H04W 72/0457; H04W 72/231

(57) ABSTRACT

A wireless network may include a device that communicates with base stations. The device may include a set of antennas. The network may transmit a message identifying a subset of frequency resources of a frequency band for the device. The subset can include a bandwidth part configuration, a component carrier configuration, and/or a physical resource block configuration. The device may generate wireless performance metric data with the set of antennas using the subset of frequency resources rather than averaging wireless performance metric data across the entire band. The device may identify a best performing antenna based on the performance metric data and may use that antenna to transmit signals. The best performing antenna may be different than when averaged across the entire frequency band, serving to optimize wireless performance particularly when the frequency band has a wide bandwidth.

This application claims the benefit of U.S. Provisional Patent Application No. 63/489,980, filed Mar. 13, 2023, which is hereby incorporated by reference herein in its entirety.

### FIELD

This disclosure relates generally to wireless communications, including wireless communications performed by user equipment devices.

### BACKGROUND

Communications systems can include electronic devices with wireless communications capabilities. Electronic devices with wireless communications capabilities can have multiple antennas for transmitting and/or receiving radio-frequency signals.

While performing wireless communications, some of the antennas in an electronic device may offer superior wireless performance than other antennas in the electronic device. Care should be taken to select the best-performing antenna for wireless communications given the operating conditions of the electronic device.

### SUMMARY

A wireless network may include a user equipment device that communicates with one or more base stations. The device may include a set of antennas. The device may perform antenna transmit diversity (ATD) operations to select a best performing antenna from the set of antennas to transmit radio-frequency signals at any given time. The network may assign a frequency band to the device for use in performing communications. The network may transmit a message to the device identifying a subset of frequency resources of the frequency band for the device to use in performing communications. The subset of frequency resources can include a bandwidth part (BWP) configuration, a component carrier (CC) configuration, and/or a physical resource block (PRB) configuration.

The device may receive reference signals using each antenna in the set of antennas. The device may generate wireless performance metric data from the received reference signals using the subset of frequency resources rather than averaging the wireless performance metric data across the entire bandwidth of the frequency band. The device may identify a best performing antenna from the set of antennas for the subset of frequency resources based on the wireless performance metric data. The best performing antenna may then be used to transmit radio-frequency signals. In this way, the best performing antenna may be selected for ATD signal transmission given the subset of the frequency resources assigned to the electronic device, which may be different from the best performing antenna when averaged across the entire frequency band. This may serve to optimize overall wireless performance for the device particularly for wide bands such as 5G frequency bands.

An aspect of the disclosure provides a method of operating an electronic device. The method can include receiving a reference signal in a frequency band using a set of antennas. The method can include receiving, from a wireless base station, a message identifying a subset of frequency resources of the frequency band. The method can include transmitting a radio-frequency signal using the subset of frequency resources identified by the message, the radio-frequency signal being transmitted by a transmit antenna from the set of antennas that is selected based on the subset of frequency resources identified by the message.

An aspect of the disclosure provides a method of operating an electronic device. The method can include receiving, at a receiver, a first message from a wireless base station identifying a first bandwidth part (BWP) configuration assigned to the electronic device. The method can include transmitting, with a first transmit antenna from the set of antennas, a first radio-frequency signal using the first BWP configuration, the first transmit antenna being selected from the set of antennas based on first wireless performance metric data generated from each antenna in the set of antennas using the first BWP configuration identified by the first message.

An aspect of the disclosure provides an electronic device. The electronic device can include one or more antennas configured to receive a message from a wireless base station identifying a primary component carrier (PCC) and a secondary component carrier assigned to the electronic device. The electronic device can include one or more processors configured to generate first wireless performance metric data from each antenna in the set of antennas using the PCC, and generate second wireless performance metric data from each antenna in the set of antennas using the SCC. The electronic device can include a transmitter configured to transmit a radio-frequency signal using a transmit antenna that is selected from the set of antennas based on the first wireless performance metric data and the second wireless performance metric data, the radio-frequency signal being transmitted using the PCC or the SCC.

### BRIEF DESCRIPTION OF THE DRAWINGS

FIG. 1 is a diagram of an illustrative communications network having a user equipment device that communicates with one or more wireless base stations in accordance with some embodiments.

FIG. 2 is a functional block diagram of an illustrative user equipment device in accordance with some embodiments.

FIG. 3 is a top interior view of an illustrative user equipment device having multiple antennas formed at different locations within the electronic device in accordance with some embodiments.

FIG. 4 is a diagram showing how an illustrative user equipment can perform wireless communications using different frequency resources of a frequency band in accordance with some embodiments.

FIG. 5 is a plot of antenna performance (signal-to-noise ratio (SNR)) showing how different antennas may exhibit superior wireless performance within different subsets of a frequency band in accordance with some embodiments.

FIG. 6 is a flow chart of illustrative operations that may be performed by a user equipment device to select a best performing transmit antenna for a bandwidth part configuration assigned to the electronic device by a wireless communications network in accordance with some embodiments.

FIG. 7 is a flow chart of illustrative operations that may be performed by a user equipment device to select a transmit antenna based on component carriers assigned to the electronic device by a wireless communications network in accordance with some embodiments.

FIG. 8 is a plot showing how an illustrative user equipment device may be assigned different frequency resources at different times in accordance with some embodiments.

FIG. 9 is a flow chart of illustrative operations that may be performed by a user equipment device to select a transmit antenna based on a physical resource block configuration assigned to the user equipment device and scheduling statistics of a wireless communications network in accordance with some embodiments.

FIG. 10 is a diagram showing how wireless performance metric data gathered while processing the operations of FIG. 9 may be aggregated into different hierarchical bins for use in selecting a transmit antenna in accordance with some embodiments.

### DETAILED DESCRIPTION

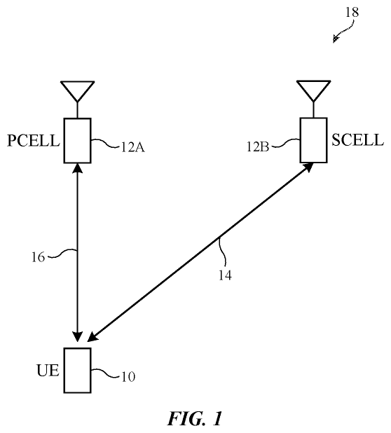

FIG. 1 is a schematic diagram of an illustrative communications system 18 (sometimes referred to herein as communications network 18) for conveying wireless data between communications terminals. System 18 may include network nodes (e.g., communications terminals). The network nodes may include user equipment (UE) such as one or more UE devices 10. The network nodes may also include external communications equipment (e.g., communications equipment other than UE devices 10) such as one or more wireless base stations 12.

It may be desirable to simultaneously receive and/or transmit radio-frequency signals in two different frequency bands to increase data throughput for UE device 10. For example, UE device 10 may communicate using a communications protocol that supports and/or is configured to support carrier aggregation (CA) schemes (e.g., a 3GPP 5G NR FR1 and/or FR2 protocol, a Long Term Evolution (LTE) protocol, a 6G protocol, etc.). By concurrently conveying wireless data using two different communications bands, UE device 10 may be provided with increased bandwidth relative to scenarios where only a single band is used. If desired, UE device 10 may simultaneously communicate with two or more base stations in two different communications bands (e.g., device 10 may perform carrier aggregation over multiple base stations). For example, in implementations that support a CA scheme, the wireless base stations 12 in system 18 may include at least a first base station (gNB) 12A and a second base station (gNB) 12B. UE device 10 may simultaneously communicate with both base station 12A and with base station 12B using the CA scheme.

When performing carrier aggregation with multiple base stations, UE device 10 may first establish a wireless connection with a single base station such as base station 12A. The first base station with which UE device 10 establishes a wireless link may sometimes be referred to herein as a Primary Component Carrier (PCC), primary base station, primary cell (PCELL) base station, or simply as a primary cell (PCELL). In the example of FIG. 1, base station 12A may be a PCELL base station and may therefore sometimes be referred to herein as PCELL base station 12A. Radio-frequency signals 16 conveyed between PCELL base station 12A and UE device 10 may sometimes be referred to herein as primary component carrier signals, primary signals, primary component signals, primary carrier signals, or PCC signals, primary cell signals, or PCELL signals (e.g., PCELL signals 16) and the wireless links between PCELL base station 12A and UE device 10 may sometimes be referred to herein as primary connections, primary wireless links, or PCELL links.

Once a primary wireless connection has been established between UE device 10 and PCELL base station 12A, UE device 10 may establish an additional (supplemental or secondary) wireless connection/link with another base station such as base station 12B (e.g., without dropping the connection with the PCELL base station). UE device 10 may then simultaneously communicate with both base stations (e.g., using different frequency resources in a carrier aggregation scheme). Additional base stations that establish a connection with UE device 10 after UE device 10 has established a wireless connection with a PCELL base station may sometimes be referred to herein as Secondary Component Carriers (SCCs), secondary base stations, or secondary cell (SCELL) base stations. In the example of FIG. 1, base station 12B may be an SCELL base station and may therefore sometimes be referred to herein as SCELL base station 12B. Radio-frequency signals 14 conveyed between the SCELL base station 12B and UE device 10 may sometimes be referred to herein as secondary component carrier signals, secondary signals, secondary component signals, secondary carrier signals, SCC signals, or SCELL signals (e.g., SCELL signals 14), and the wireless links between the SCELL base station 12B and UE device 10 may sometimes be referred to herein as secondary connections or secondary wireless links.

UE device 10 may establish a connection with a primary base station and one or more secondary base stations at downlink and uplink frequencies (e.g., downlink and uplink frequency bands). In other words, UE device 10 may perform wireless communications with base stations 12A and 12B using a carrier aggregation (CA) scheme in which radio-frequency signals are concurrently conveyed in uplink and/or downlink directions at one or more different frequencies (e.g., using one or more different component carriers) with both base station 12A and base station 12B. For example, during wireless communications, UE device 10 may concurrently transmit uplink (UL) signals in multiple frequency ranges (e.g., using multiple different uplink component carriers) to base station 12A and base station 12B. UE device 10 may also concurrently receive downlink (DL) signals from base station 12A and base station 12B in multiple frequency ranges (e.g., using multiple different downlink component carriers).

At a given moment in time, base station 12A may be a primary cell (PCELL) base station 12. PCELL Base station 12 may communicate with UE device 10 using radio-frequency signals 16 (primary cell signals 16 or PCELL signals 16). Radio-frequency signals 16 may be at first frequencies (e.g., PCELL frequencies or a PCELL carrier). On the other hand, base station 12B may be a secondary cell (SCELL) base station 12B. SCELL Base station 12B may communicate with UE device 10 using radio-frequency signals 14 (secondary cell signals 14 or SCELL signals 14). Radio-frequency signals 14 may be at second frequencies (e.g., SCELL frequencies or an SCELL carrier). The assignment of different base stations as a PCELL base station or an SCELL base station may change over time.

System 18 may form a part of a larger communications network that includes network nodes coupled to base stations 12 via wired and/or wireless links. The larger communications network may include one or more wired communications links (e.g., communications links formed using cabling such as ethernet cables, radio-frequency cables such as coaxial cables or other transmission lines, optical fibers or other optical cables, etc.), one or more wireless communications links (e.g., short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles, etc.), communications gateways, wireless access points, base stations, switches, routers, servers, modems, repeaters, telephone lines, network cards, line cards, portals, user equipment (e.g., computing devices, mobile devices, etc.), etc. The larger communications network may include communications (network) nodes or terminals coupled together using these components or other components (e.g., some or all of a mesh network, relay network, ring network, local area network, wireless local area network, personal area network, cloud network, star network, tree network, or networks of communications nodes having other network topologies), the Internet, combinations of these, etc. UE device 10 may send data to and/or may receive data from other nodes or terminals in the larger communications network via base stations 12 (e.g., base stations 12A and 12B may serve as an interface between UE device 10 and the rest of the larger communications network). Some or all of the communications network may, if desired, be operated by a corresponding network operator or service provider. Base stations 12 and nodes of communications system 38 other than UE device 10 may sometimes be referred to herein collectively as “the network.”

Wireless base stations 12A and 12B may each include one or more antennas that provide wireless coverage for UE devices located within corresponding geographic areas or regions, sometimes referred to as cells. The size of the cells may correspond to the maximum transmit power level of the wireless base stations and the over-the-air attenuation characteristics for radio-frequency signals conveyed by the wireless base stations, for example.

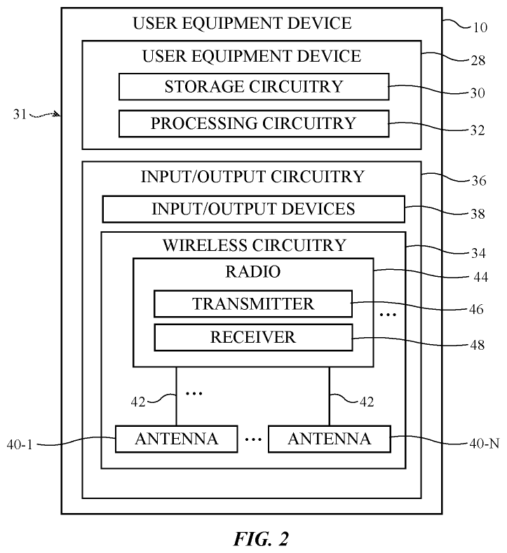

FIG. 2 is a block diagram of an illustrative UE device 10. UE device 10 may be an electronic device that is owned and/or operated by a user and that wirelessly communicates with external communications equipment. The external communications equipment may include a wireless base station (e.g., base stations 12 of FIG. 1), an access point, or another UE device, as examples. UE device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, equipment that implements the functionality of two or more of these devices, or other electronic equipment.

As shown in FIG. 2, UE device 10 may include components located on or within an electronic device housing such as housing 31. Housing 31, which may sometimes be referred to as a case, may be formed of plastic, glass, ceramics, fiber composites, metal (e.g., stainless steel, aluminum, metal alloys, etc.), other suitable materials, or a combination of these materials. In some situations, parts or all of housing 31 may be formed from dielectric or other low-conductivity material (e.g., glass, ceramic, plastic, sapphire, etc.). In other situations, housing 31 or at least some of the structures that make up housing 31 may be formed from metal elements.

UE device 10 may include control circuitry 28. Control circuitry 28 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 30 may include storage that is integrated within UE device 10 and/or removable storage media.

Control circuitry 28 may include processing circuitry such as processing circuitry 32. Processing circuitry 32 may be used to control the operation of UE device 10. Processing circuitry 32 may include on one or more processors such as microprocessors, microcontrollers, digital signal processors, host processors, baseband processor integrated circuits, application specific integrated circuits, central processing units (CPUs), graphics processing units (GPUs), etc. Control circuitry 28 may be configured to perform operations in UE device 10 using hardware (e.g., dedicated hardware or circuitry), firmware, and/or software. Software code for performing operations in UE device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 28 may be used to run software on UE device 10 such as one or more software applications (apps). The applications may include satellite navigation applications, internet browsing applications, voice-over-internet-protocol (VOIP) telephone call applications, email applications, media playback applications, operating system functions, gaming applications, productivity applications, workplace applications, augmented reality (AR) applications, extended reality (XR) applications, virtual reality (VR) applications, scheduling applications, consumer applications, social media applications, educational applications, banking applications, spatial ranging applications, sensing applications, security applications, media applications, streaming applications, automotive applications, video editing applications, image editing applications, rendering applications, simulation applications, camera-based applications, imaging applications, news applications, and/or any other desired software applications.

To support interactions with external communications equipment, control circuitry 28 may be used in implementing communications protocols. Communications protocols that may be implemented using control circuitry 28 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, 6G protocols, cellular sideband protocols, etc.), device-to-device (D2D) protocols, antenna diversity protocols, satellite navigation system protocols (e.g., global positioning system (GPS) protocols, global navigation satellite system (GLONASS) protocols, etc.), antenna-based spatial ranging protocols, or any other desired communications protocols. Each communications protocol may be associated with a corresponding radio access technology (RAT) that specifies the physical connection methodology used in implementing the protocol. Radio-frequency signals conveyed using a cellular telephone protocol may sometimes be referred to herein as cellular telephone signals.

UE device 10 may include input-output circuitry 36. Input-output circuitry 36 may include input-output devices 38. Input-output devices 38 may be used to allow data to be supplied to UE device 10 and to allow data to be provided from UE device 10 to external devices. Input-output devices 38 may include user interface devices, data port devices, and other input-output components. For example, input-output devices 38 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to UE device 10 using wired or wireless connections (e.g., some of input-output devices 38 may be peripherals that are coupled to a main processing unit or other portion of UE device 10 via a wired or wireless link).

Input-output circuitry 36 may include wireless circuitry 34 to support wireless communications. Wireless circuitry 34 (sometimes referred to herein as wireless communications circuitry 34) may include one or more antennas 40. In some implementations that are described herein as an example, wireless circuitry 34 includes a set of N antennas 40 (e.g., a first antenna 40-1, an Nth antenna 40-N, etc.). Wireless circuitry 34 may also include one or more radios 44. Radio 44 may include circuitry that operates on signals at baseband frequencies (e.g., baseband circuitry) and radio-frequency transceiver circuitry such as one or more radio-frequency transmitters 46 and one or more radio-frequency receivers 48. Transmitter 46 may include signal generator circuitry, modulation circuitry, mixer circuitry for upconverting signals from baseband frequencies to intermediate frequencies and/or radio frequencies, amplifier circuitry such as one or more power amplifiers, digital-to-analog converter (DAC) circuitry, control paths, power supply paths, switching circuitry, filter circuitry, and/or any other circuitry for transmitting radio-frequency signals using antennas 40. Receiver 48 may include demodulation circuitry, mixer circuitry for downconverting signals from intermediate frequencies and/or radio frequencies to baseband frequencies, amplifier circuitry (e.g., one or more low-noise amplifiers (LNAs)), analog-to-digital converter (ADC) circuitry, control paths, power supply paths, signal paths, switching circuitry, filter circuitry, and/or any other circuitry for receiving radio-frequency signals using antennas 40. The components of radio 44 may be mounted onto a single substrate or integrated into a single integrated circuit, chip, package, or system-on-chip (SOC) or may be distributed between multiple substrates, integrated circuits, chips, packages, or SOCs.

Antennas 40 may be formed using any desired antenna structures for conveying radio-frequency signals. For example, antennas 40 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of antennas 40 over time. If desired, two or more of antennas 40 may be integrated into a phased antenna array (sometimes referred to herein as a phased array antenna) in which each of the antennas conveys radio-frequency signals with a respective phase and magnitude that is adjusted over time so the radio-frequency signals constructively and destructively interfere to produce a signal beam in a given pointing direction.

The term “convey radio-frequency signals” as used herein means the transmission and/or reception of the radio-frequency signals (e.g., for performing unidirectional and/or bidirectional wireless communications with external wireless communications equipment). Antennas 40 may transmit the radio-frequency signals by radiating the radio-frequency signals into free space (or to free space through intervening device structures such as a dielectric cover layer). Antennas 40 may additionally or alternatively receive the radio-frequency signals from free space (e.g., through intervening devices structures such as a dielectric cover layer). The transmission and reception of radio-frequency signals by antennas 30 each involve the excitation or resonance of antenna currents on an antenna resonating element in the antenna by the radio-frequency signals within the frequency band(s) of operation of the antenna.

Each radio 44 may be coupled to one or more antennas 40 over one or more radio-frequency transmission lines 42. Radio-frequency transmission lines 42 may include coaxial cables, microstrip transmission lines, stripline transmission lines, edge-coupled microstrip transmission lines, edge-coupled stripline transmission lines, transmission lines formed from combinations of transmission lines of these types, etc. Radio-frequency transmission lines 42 may be integrated into rigid and/or flexible printed circuit boards if desired. One or more radio-frequency lines 42 may be shared between multiple radios 44 if desired. Radio-frequency front end (RFFE) modules may be interposed on one or more radio-frequency transmission lines 42. The radio-frequency front end modules may include substrates, integrated circuits, chips, or packages that are separate from radios 44 and may include filter circuitry, switching circuitry, amplifier circuitry, impedance matching circuitry, radio-frequency coupler circuitry, and/or any other desired radio-frequency circuitry for operating on the radio-frequency signals conveyed over radio-frequency transmission lines 42.

Radio 44 may transmit and/or receive radio-frequency signals within corresponding frequency bands at radio frequencies (sometimes referred to herein as communications bands or simply as “bands”). The frequency bands handled by radio 44 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz, or other cellular communications bands between about 600 MHz and about 5000 MHz), 3G bands, 4G LTE bands, 3GPP 5G New Radio Frequency Range 1 (FR1) bands below 10 GHz, 3GPP 5G New Radio (NR) Frequency Range 2 (FR2) bands between 20 and 60 GHz, other centimeter or millimeter wave frequency bands between 10-300 GHz, near-field communications frequency bands (e.g., at 13.56 MHz), satellite navigation frequency bands such as the Global Positioning System (GPS) L1 band (e.g., at 1575 MHz), L2 band (e.g., at 1228 MHz), L3 band (e.g., at 1381 MHz), L4 band (e.g., at 1380 MHz), and/or L5 band (e.g., at 1176 MHz), a Global Navigation Satellite System (GLONASS) band, a BeiDou Navigation Satellite System (BDS) band, ultra-wideband (UWB) frequency bands that operate under the IEEE 802.15.4 protocol and/or other ultra-wideband communications protocols (e.g., a first UWB communications band at 6.5 GHz and/or a second UWB communications band at 8.0 GHz), communications bands under the family of 3GPP wireless communications standards, communications bands under the IEEE 802.XX family of standards, satellite communications bands such as an L-band, S-band (e.g., from 2-4 GHz), C-band (e.g., from 4-8 GHz), X-band, Ku-band (e.g., from 12-18 GHz), Ka-band (e.g., from 26-40 GHz), etc., industrial, scientific, and medical (ISM) bands such as an ISM band between around 900 MHz and 950 MHz or other ISM bands below or above 1 GHz, one or more unlicensed bands, one or more bands reserved for emergency and/or public services, and/or any other desired frequency bands of interest. Wireless circuitry 34 may also be used to perform spatial ranging operations if desired.

Transmitter 46 may transmit radio-frequency signals over antenna(s) 40 when transmitter 46 is active (e.g., enabled). Transmitter 46 does not transmit radio-frequency signals over antenna(s) 40 when transmitter 46 is inactive (e.g., disabled or not actively transmitting sign). Similarly, receiver 48 may receive radio-frequency signals over antenna(s) 40 when receiver 48 is active (e.g., enabled). Receiver 48 does not receive radio-frequency signals over antenna(s) 40 when receiver 48 is inactive (e.g., disabled). Control circuitry 28 may control transmitter 46 to be active or inactive at any given time. Control circuitry 28 may also control receiver 48 to be active or inactive at any given time. Control circuitry 28 may activate or deactivate transmitter 46 and/or receiver 48 at different times as dictated by a communications protocol governing radio 44 and/or based on instructions provided by a user and/or from other software running on control circuitry 28, for example.

Control circuitry 28 may configure transmitter 46 to be inactive by powering off transmitter 46, by providing control signals to switching circuitry on power supply or enable lines for transmitter 46, by providing control signals to control circuitry on transmitter 46, and/or by providing control signals to switching circuitry within transmitter 46, for example. When transmitter 46 is inactive, some or all of transmitter 46 may be inactive (e.g., disabled or powered off) or transmitter 46 may remain powered on but without transmitting radio-frequency signals over antenna(s) 40. Similarly, control circuitry 28 may configure receiver 48 to be inactive by powering off receiver 48, by providing control signals to switching circuitry on power supply or enable lines for receiver 48, by providing control signals to control circuitry on receiver 48, and/or by providing control signals to switching circuitry within receiver 48, for example. When receiver 48 is inactive, some or all of receiver 48 may be disabled (e.g., powered off) or receiver 48 may remain powered on but without actively receiving radio-frequency signals incident upon antenna(s) 40. Transmitter 46 and receiver 48 may consume more power on UE device 10 when active than when inactive (e.g., a battery on UE device 10 may drain more rapidly while transmitter 46 and receiver 48 are active than while transmitter 46 or receiver 48 are inactive). Transitioning transmitter 46 or receiver 48 from an inactive state to an active state may sometimes be referred to herein as waking the transmitter or receiver.

The example of FIG. 2 is illustrative and non-limiting. While control circuitry 28 is shown separately from wireless circuitry 34 in the example of FIG. 1 for the sake of clarity, wireless circuitry 34 may include processing circuitry (e.g., one or more processors) that forms a part of processing circuitry 32 and/or storage circuitry that forms a part of storage circuitry 30 of control circuitry 28 (e.g., portions of control circuitry 28 may be implemented on wireless circuitry 34). As an example, control circuitry 28 may include baseband circuitry (e.g., one or more baseband processors), digital control circuitry, analog control circuitry, and/or other control circuitry that forms part of radio 44. The baseband circuitry may, for example, access a communication protocol stack on control circuitry 28 (e.g., storage circuitry 30) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer. If desired, the PHY layer operations may additionally or alternatively be performed by radio-frequency (RF) interface circuitry in wireless circuitry 34.

The communications protocol governing radio-frequency signals 16 and 14 of FIG. 1 may support carrier aggregation (CA) operations. CA operations may include standalone (SA) CA operations and non-standalone (non-SA) CA operations. SA CA operations involve using only a 5G NR communications protocol to support radio-frequency signals 16 and 14 (e.g., both the PCELL signals and the SCELL signals are conveyed over 5G NR frequency bands). Non-SA CA operations involve using the LTE communications protocol as an anchor for radio-frequency signals 16 and 14 while also using the 5G NR communications protocol to boost the anchor. UE device 10 may convey data or voice traffic with PCELL base station 12A and SCELL base station 14B over SA CA, for example.

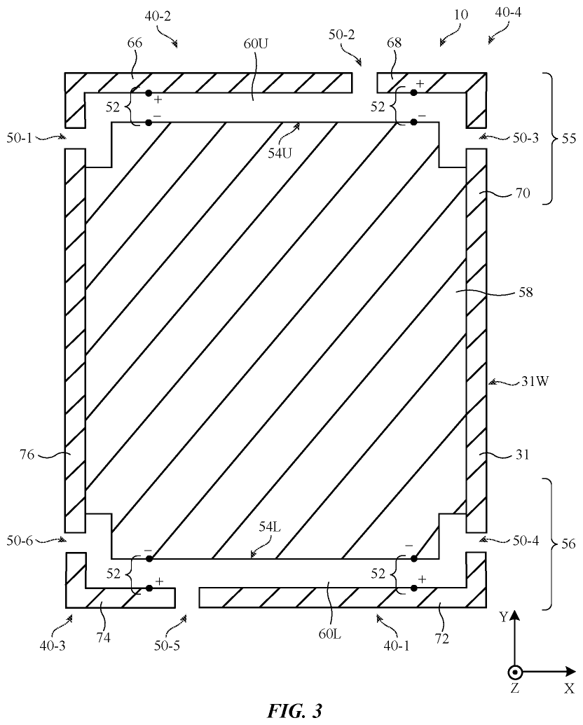

UE device 10 may include a set of N antennas 40 disposed at various locations on or around UE device 10. If desired, the N antennas 40 may include at least four antennas having resonating elements formed from peripheral conductive housing structures in housing 31. FIG. 3 is a top interior view showing how UE device 10 may include at least four antennas having resonating elements formed from peripheral conductive housing structures in housing 31.

As shown in FIG. 3, housing 31 may include peripheral housing structures such as peripheral structures 31W. Peripheral structures 31W may run around the lateral periphery of device 10. In configurations in which UE device 10 has a rectangular shape with four edges, peripheral structures 31W may be implemented using peripheral housing structures that have a rectangular ring shape with four corresponding edges and that extend from the rear wall of housing 31 to the front face of UE device 10. UE device 10 may have a display that extends across some or all of the front face. In other words, UE device 10 may have a length (e.g., measured parallel to the Y-axis), a width that is less than the length (e.g., measured parallel to the X-axis), and a height (e.g., measured parallel to the Z-axis) that is less than the width. Peripheral structures 31W or part of peripheral structures 31W may serve as a bezel for a display (e.g., a cosmetic trim that surrounds all four sides of the display and/or that helps hold the display to UE device 10) if desired. Peripheral structures 31W may, if desired, form sidewall structures for UE device 10 (e.g., by forming a metal band with vertical sidewalls, curved sidewalls, etc.).

Peripheral structures 31W may be formed of a conductive material such as metal and may therefore sometimes be referred to as peripheral conductive housing structures, conductive housing structures, peripheral metal structures, peripheral conductive sidewalls, peripheral conductive sidewall structures, conductive housing sidewalls, peripheral conductive housing sidewalls, sidewalls, sidewall structures, or a peripheral conductive housing member (as examples). Peripheral conductive housing structures 31W may be formed from a metal such as stainless steel, aluminum, alloys, or other suitable materials. One, two, or more than two separate structures may be used in forming peripheral conductive housing structures 31W.

It is not necessary for peripheral conductive housing structures 31W to have a uniform cross-section. For example, the top portion of peripheral conductive housing structures 31W may, if desired, have an inwardly protruding ledge that helps hold the display in place. The bottom portion of peripheral conductive housing structures 31W may also have an enlarged lip (e.g., in the plane of the rear surface of UE device 10). Peripheral conductive housing structures 31W may have substantially straight vertical sidewalls, may have sidewalls that are curved, or may have other suitable shapes. In some configurations (e.g., when peripheral conductive housing structures 31W serve as a bezel for the display), peripheral conductive housing structures 31W may run around the lip of housing 31 (i.e., peripheral conductive housing structures 31W may cover only the edge of housing 31 that surrounds the display and not the rest of the sidewalls of housing 31).

The rear housing wall of housing 31 may lie in a plane that is parallel to the display of UE device 10. In configurations for UE device 10 in which some or all of the rear housing wall is formed from metal, it may be desirable to form parts of peripheral conductive housing structures 31W as integral portions of the housing structures forming the rear housing wall. For example, the rear housing wall of UE device 10 may include a planar metal structure and portions of peripheral conductive housing structures 31W on the sides of housing 31 may be formed as flat or curved vertically extending integral metal portions of the planar metal structure (e.g., housing structures 31W and the rear housing wall may be formed from a continuous piece of metal in a unibody configuration). Housing structures such as these may, if desired, be machined from a block of metal and/or may include multiple metal pieces that are assembled together to form housing 31. The rear housing wall may have one or more, two or more, or three or more portions. Peripheral conductive housing structures 31W and/or conductive portions of the rear housing wall may form one or more exterior surfaces of UE device 10 (e.g., surfaces that are visible to a user of UE device 10) and/or may be implemented using internal structures that do not form exterior surfaces of UE device 10 (e.g., conductive housing structures that are not visible to a user of UE device 10 such as conductive structures that are covered with layers such as thin cosmetic layers, protective coatings, and/or other coating/cover layers that may include dielectric materials such as glass, ceramic, plastic, or other structures that form the exterior surfaces of UE device 10 and/or serve to hide peripheral conductive housing structures 31W and/or conductive portions of the rear housing wall from view of the user).

As shown in FIG. 3, peripheral conductive housing structures 31W may include a first conductive sidewall at the left edge of UE device 10, a second conductive sidewall at the top edge of UE device 10, a third conductive sidewall at the right edge of UE device 10, and a fourth conductive sidewall at the bottom edge of UE device 10 (e.g., in an example where UE device 10 has a substantially rectangular lateral shape). Peripheral conductive housing structures 31W may be segmented by dielectric-filled gaps 50 such as a first gap 50-1, a second gap 50-2, a third gap 50-3, a fourth gap 50-4, a fifth gap 50-5, and a sixth gap 50-6. Gaps 50-1, 50-2, 50-3, 50-4, 50-5, and 50-6 may be filled with plastic, ceramic, sapphire, glass, epoxy, or other dielectric materials. The dielectric material in the gaps may lie flush with peripheral conductive housing structures 31W at the exterior surface of UE device 10 if desired.

Gap 50-1 may divide the first conductive sidewall to separate segment 76 of peripheral conductive housing structures 31W from segment 66 of peripheral conductive housing structures 31W. Gap 50-2 may divide the second conductive sidewall to separate segment 66 from segment 68 of peripheral conductive housing structures 31W. Gap 50-3 may divide the third conductive sidewall to separate segment 68 from segment 70 of peripheral conductive housing structures 31W. Gap 50-4 may divide the third conductive sidewall to separate segment 70 from segment 72 of peripheral conductive housing structures 31W. Gap 50-5 may divide the fourth conductive sidewall to separate segment 72 from segment 74 of peripheral conductive housing structures 31W. Gap 50-6 may divide the first conductive sidewall to separate segment 74 from segment 76.

In this example, segment 66 forms the top-left corner of UE device 10 (e.g., segment 66 may have a bend at the corner) and is formed from the first and second conductive sidewalls of peripheral conductive housing structures 31W (e.g., in upper region 55 of UE device 10). Segment 68 forms the top-right corner of UE device 10 (e.g., segment 68 may have a bend at the corner) and is formed from the second and third conductive sidewalls of peripheral conductive housing structures 31W (e.g., in upper region 55 of UE device 10). Segment 72 forms the bottom-right corner of UE device 10 and is formed from the third and fourth conductive sidewalls of peripheral conductive housing structures 31W (e.g., in lower region 56 of UE device 10). Segment 74 forms the bottom-left corner of UE device 10 and is formed from the fourth and first conductive sidewalls of peripheral conductive housing structures 31W (e.g., in lower region 56 of UE device 10).

A conductive layer such as conductive support plate 58 may extend between opposing sidewalls of peripheral conductive housing structures 31W. For example, conductive support plate 58 may extend from segment 76 to segment 70 of peripheral conductive housing structures 31W (e.g., across the width of UE device 10, parallel to the X-axis). Conductive support plate 58 may be welded or otherwise affixed to segments 76 and 70. In another arrangement, conductive support plate 58, segment 76, and segment 70 may be formed from a single, integral (continuous) piece of machined metal (e.g., in a unibody configuration).

As shown in FIG. 3, housing 31 may include multiple slots 60. For example, UE device 10 may include an upper slot such as slot 60U in upper region 55 and a lower slot such as slot 60L in lower region 56. The lower edge of slot 60U may be defined by upper edge 54U of conductive support plate 58. The upper edge of slot 60U may be defined by segments 66 and 68 (e.g., slot 60U may be interposed between conductive support plate 58 and segments 66 and 68 of peripheral conductive housing structures 31W). The upper edge of slot 60L may be defined by lower edge 54L of conductive support plate 58. The lower edge of slot 60L may be defined by segments 74 and 72 (e.g., slot 60L may be interposed between conductive support plate 58 and segments 74 and 72 of peripheral conductive housing structures 31W).

Slot 60U may have an elongated shape extending from a first end at gap 50-2 to an opposing second end at gap 50-3 (e.g., slot 60U may span the width of UE device 10). Similarly, slot 60L may have an elongated shape extending from a first end at gap 50-6 to an opposing second end at gap 50-4 (e.g., slot 60L may span the width of UE device 10). Slots 60U and 60L may be filled with air, plastic, glass, sapphire, epoxy, ceramic, or other dielectric material. Slot 60U may be continuous with gaps 50-1, 50-2, and 50-3 in peripheral conductive housing structures 31W if desired (e.g., a single piece of dielectric material may be used to fill both slot 60U and gaps 50-1, 50-2, and 50-3). Similarly, slot 60L may be continuous with gaps 50-6, 50-5, and 50-4 if desired (e.g., a single piece of dielectric material may be used to fill both slot 60L and gaps 50-6, 50-5, and 50-4).

Conductive support plate 58, segment 66, segment 68, and portions of slot 60U may be used in forming multiple antennas 40 in upper region 55 of UE device 10 (sometimes referred to herein as upper antennas). Conductive support plate 58, portions of slot 60L, segment 74, and segment 72 may be used in forming multiple antennas 40 in lower region 56 of UE device 10 (sometimes referred to herein as lower antennas). For example, UE device 10 may include at least a first antenna 40-1, a second antenna 40-2, a third antenna 40-3, and a fourth antenna 40-4. Conductive support plate 58 may form part of an antenna ground for antennas 40-1 through 40-4. Peripheral conductive housing structures 31W may form antenna resonating element arms for the antennas.

For example, antenna 40-1 may have an antenna resonating element arm formed from segment 72 and may be fed by a corresponding antenna feed 52 coupled between conductive support plate 58 and segment 72. Antenna 40-2 may have an antenna resonating element arm formed from segment 66 and may be fed by a corresponding antenna feed 52 coupled between conductive support plate 58 and segment 66. Antenna 40-3 may have an antenna resonating element arm formed from segment 74 and may be fed by a corresponding antenna feed 52 coupled between conductive support plate 58 and segment 74. Antenna 40-4 may have an antenna resonating element arm formed from segment 68 and may be fed by a corresponding antenna feed 52 coupled between conductive support plate 58 and segment 68. UE device 10 may also include additional antennas disposed elsewhere in UE device 10. Any of these antennas may be integrated into a phased antenna array if desired.

If desired, two or more of antennas 40-1, 40-2, 40-3, 40-4, and/or the other antennas 40 in UE device 10 may convey radio-frequency signals in one or more of the same frequency bands. In implementations where multiple antennas 40 transmit radio-frequency signals in the same frequency band, UE device 10 may implement an antenna transmit diversity (ATD) scheme to select a single one of those antennas 40 to transmit radio-frequency signals in the frequency band at any given time. The selected antenna 40 may sometimes be referred to herein as a transmit antenna (e.g., an antenna that transmits radio-frequency signals, as selected using the ATD scheme). While referred to herein as a transmit antenna, the transmit antenna may also receive radio-frequency signals if desired. When a given antenna 40 that transmits radio-frequency signals in the frequency band is blocked or loaded by a user's hand, other body parts, a tabletop, clothing, or other external objects, a different antenna 40 may be switched into use to transmit radio-frequency signals in the frequency band. For example, when a user is holding the bottom-right of UE device 10 with their hand, the user's hand may block antenna 40-1 from transmitting radio-frequency signals in a given frequency band. UE device 10 may then switch antenna 40-2 into use for transmitting radio-frequency signals in the given frequency band (e.g., without being blocked by the user's hand).

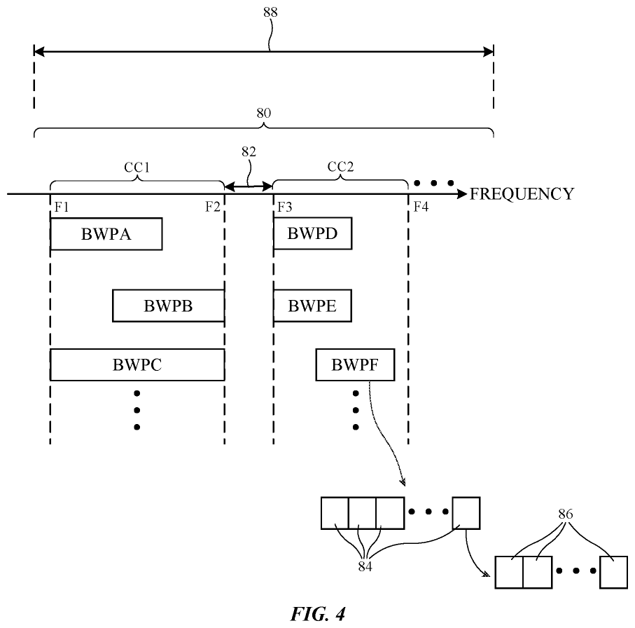

While performing wireless communications, the network assigns (schedules) time and frequency resources for UE device 10 to transmit and/or receive radio-frequency signals. FIG. 4 is a diagram showing illustrative frequency resources that may be assigned to UE device 10 for conveying radio-frequency signals (e.g., with one or both of base stations 12A and 12B of FIG. 1).

As shown in FIG. 4, the network may assign a frequency band 80 for UE device 10 to transmit and/or receive radio-frequency signals. Frequency band 80 may have a corresponding bandwidth 88. Frequency band 80 may be divided into a number of frequency ranges sometimes referred to as component carriers (CCs). For example, frequency band 80 may include at least a first component carrier CC1 and a second component carrier CC2. Frequency band 80 may be a 5G NR FR1 or FR2 frequency band (e.g., a frequency band as defined by the 5G protocol) and component carriers CC1 and CC2 may be component carriers of the 5G NR FR1 or FR2 frequency band, for example.

Component carrier CC1 extends from frequency F1 to frequency F2 whereas component carrier CC2 extends from frequency F3 to frequency F4. The bandwidth of component carrier CC1 is defined as the difference between frequency F2 and frequency F1 whereas the bandwidth of component carrier CC2 is defined as the difference between frequency F4 and frequency F3. Component carrier CC1 may be separated from component carrier CC2 by frequency separation 82.

The example of FIG. 4 in which component carriers CC1 and CC2 belong to the same frequency band 80 is illustrative and non-limiting. If desired, component carrier CC1 may belong to a first frequency band whereas component carrier CC2 belongs to a second frequency band (e.g., component carriers CC1 and CC2 may be inter-band component carriers). In this situation, frequency separation 82 includes at least the distance in frequency between the first and second frequency bands.

In the example of FIG. 4 in which component carriers CC1 and CC2 are both within frequency band 80, frequency separation 82 may be non-zero or may be equal to zero. When frequency separation 82 is non-zero, component carriers CC1 and CC2 may sometimes be referred to as non-contiguous intra-band component carriers of frequency band 80. When frequency separation 82 is zero, component carriers CC1 and CC2 may sometimes be referred to as contiguous intra-band component carriers of frequency band 80. The difference between frequency F4 and frequency F1 defines the frequency separation class of component carriers CC1 and CC2. In scenarios where component carriers CC1 and CC2 are non-contiguous intra-band component carriers, the frequency separation class of component carriers CC1 and CC2 may be values in the range of 800 to 1400 MHz and in the range of 800 to 2400 MHz, as just two examples.

Component carriers CC1 and CC2 may each include multiple bandwidth parts (BWPs). Each bandwidth part may extend (in frequency) across some or all of the bandwidth of its corresponding component carrier. Each BWP may include a set of contiguous physical resource blocks 84 of the corresponding component carrier. Each physical resource block (PRB) 84 is divided in the frequency domain into a corresponding set of contiguous resource elements (RE) 86. Each RE 86 is the smallest unit of the resource grid defined by the communications protocol governing frequency band 80. For example, each RE 86 may be defined by a single subcarrier in frequency and a single symbol in the time domain.

Each component carrier CC may have any desired number of BWPs (e.g., as defined by the corresponding communications protocol). In the example of FIG. 4, component carrier CC1 has at least three bandwidth parts BWPA, BWPB, and BWPC whereas component carrier CC2 has at least three bandwidth parts BWPD, BWPE, and BWPF. Each bandwidth part may occupy a respective subset of the frequency resources of its component carrier (e.g., different ranges of frequencies between frequencies F1 and F2 for component carrier CC1 and different ranges of frequencies between frequencies F3 and F4 for component carrier CC2). If desired, one or more of the BWPs may extend across the entire bandwidth of the corresponding component carrier, such as bandwidth part BWPC of component carrier CC1. The example of FIG. 4 is illustrative and non-limiting. In general, the component carriers may include a number of configured bandwidth parts having any desired bandwidths extending between any desired frequencies (e.g., as allowed by the 3GPP NR physical layer specification). The set of one or more BWPs assigned to UE device 10 and the corresponding hardware setting on UE device 10 to communicate using that set of one or more BWPs may sometimes be referred to herein as the BWP configuration of UE device 10.

In transmitting radio-frequency signals under a transmit diversity scheme, control circuitry 28 (FIG. 2) may select one of the antennas 40 from the set of N antennas 40 in device 10 (FIG. 1) (e.g., one of antennas 40-1 through 40-4 of FIG. 3) to transmit radio-frequency signals in a given frequency band such as frequency band 80 at any given time. Control circuitry 28 may perform the selection based on wireless performance metric data gathered by each of the N antennas 40. For example, each of the N antennas 40 may receive a signal transmitted by a base station, control circuitry 28 may evaluate the reference signal received power (RSRP) of the signals received by each of the N antennas, and can select the antenna 40 having the highest RSRP as the active antenna for transmitting radio-frequency signals. This may, for example, allow the control circuitry to select antenna 40-2 (FIG. 2) for transmission when antenna 40-1 is being blocked by the user's hand. Wireless performance metric data as described herein may include received power levels, received signal strength indicator (RSSI) values, RSRP values, SNR values, signal to interference plus noise (SINR) values, noise floor values, error rate values, sensitivity values, impedance measurements, or any other desired metrics characterizing the radio-frequency performance of antennas 40.

In some implementations, control circuitry 28 performs antenna selection by averaging the wireless performance metric data gathered by each antenna 40 over the entire bandwidth 88 of frequency band 80. For older communications protocols such as LTE, bandwidth 88 is relatively small (e.g., less than 10 MHz). However, for newer communications protocols such as 5G protocols, bandwidth 88 can be so large (e.g., as high as 100-500 MHz) that the wireless performance of any given antenna 40 may vary excessively between different frequencies within bandwidth 88 itself. As such, different antennas 40 may exhibit better wireless performance for transmitting radio-frequency signals than others at different frequencies within frequency band 80, depending on the frequency resources within frequency band 80 used by UE device 10.

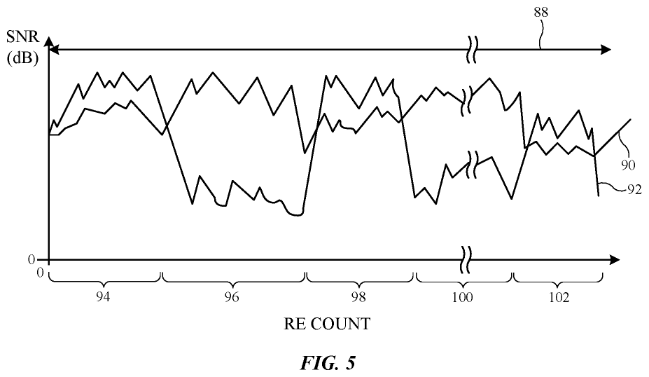

FIG. 5 is a plot of antenna performance (e.g., wireless performance metric values such as SNR values) as a function of frequency (e.g., RE index or count) showing how different antennas may exhibit different levels of performance within frequency band 80. Curve 90 plots the performance of a first antenna 40 such as antenna 40-1 (FIG. 3). Curve 92 plots the performance of a second antenna 40 such as antenna 40-2 (FIG. 3).

As shown by curves 90 and 92, antenna 40-2 may exhibit superior performance (e.g., higher SNR) at frequencies within portions 94, 98, and 102 of the bandwidth 88 of frequency band 80. On the other hand, antenna 40-1 may exhibit superior performance at frequencies within portions 96 and 100 of the bandwidth 88 of frequency band 80. In addition, antenna 40-1 may exhibit a higher SNR when averaged across the entire bandwidth 88. If the network assigns (schedules) UE device 10 frequency resources within portion 96 or 100 of bandwidth 88 for transmitting radio-frequency signals, averaging SNR across bandwidth 88 may yield the correct selection of antenna 40-1 as the best-performing antenna for transmitting the radio-frequency signals. However, if the network assigns UE device 10 frequency resources within portion 94, 98, or 102 of bandwidth 88 for transmitting radio-frequency signals, averaging SNR across bandwidth 88 would yield the incorrect selection of antenna 40-1 as the best-performing antenna for transmitting the radio-frequency signals, despite antenna 40-2 actually exhibiting superior performance when using these subsets of frequency resources in bandwidth 88. Subsequent use of antenna 40-1 for transmitting signals would then produce worse wireless performance for UE device 10 than had antenna 40-2 been selected to transmit the signals.

To mitigate the risk of selecting a sub-optimal antenna for transmitting radio-frequency signals when communicating using a transmit diversity scheme, control circuitry 28 (FIG. 2) may select the antenna 40 to use for transmitting radio-frequency signals based on the subset of the frequency resources within frequency band 80 (e.g., the subset of frequency resources of bandwidth 88) that are assigned to UE device 10 by the network. As three examples, UE device 10 may select an antenna for transmitting the radio-frequency signals based on the BWP(s), CC(s), and/or PRB(s) assigned to UE device 10 by the network.

Consider a situation in which the network schedules UE device 10 to switch from using a first BWP (e.g., a first BWP configuration) to a second BWP (e.g., a second BWP configuration). For example, the network may configure a relatively small (narrow bandwidth) BWP when UE device 10 needs or exhibits a relatively low data rate to reduce power consumption on UE device 10. The network may switch UE device 10 to a relatively large (wide bandwidth) BWP when UE device 10 needs or exhibits a relatively high data rate or when the network is congested. In implementations where UE device 10 averages the wireless performance metric data across all of bandwidth 88 while selecting an antenna to use for transmit diversity, UE device 10 will always use the same antenna 40 to transmit the radio-frequency signals using the first BWP and the second BWP. However, given the wide bandwidth 88 of frequency band 80, the same antenna 40 may not be the best performing antenna in both the first BWP and the second BWP. As such, control circuitry 28 may select an antenna 40 to use for transmit diversity based on the BWP (e.g., the BWP configuration) assigned to UE device 10 by the network.

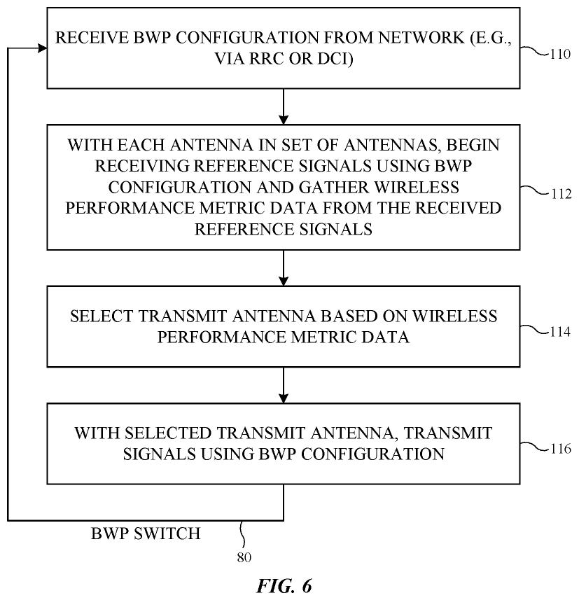

FIG. 6 is a flow chart of illustrative operations that may be performed by UE device 10 to select an antenna 40 for use in transmit diversity based on the BWP(s) assigned to UE device 10 by the network.

At operation 110, UE device 10 may receive a message from the network (e.g., a base station 12) that identifies a BWP configuration (e.g., a set of one or more BWPs) for UE device 10 as assigned (scheduled) by the network. The message may include information identifying a particular BWP (e.g., a BWP identifier) of a corresponding CC of a corresponding frequency band 80 for use by UE device 10 in transmitting subsequent radio-frequency signals. UE device 10 may receive the message as a radio resource control (RRC) message or in downlink channel information (DCI) (e.g., over a physical downlink control channel (PDCCH)) transmitted by the base station, as two examples.

At operation 112, UE device 10 may begin receiving reference signals transmitted by the base station using each of the antennas 40 in its set of N antennas 40. The reference signals may include channel state information reference signals (CSI-RS), tracking reference signals (TRS), or any other desired reference signals. Control circuitry 28 may gather (e.g., generate, produce, calculate, estimate, etc.) wireless performance metric data from, using, or based on the reference signals received by each of the N antennas 40 using (in) the identified BWP(s) (e.g., control circuitry 28 may measure the reference signals within the BWP(s) identified at operation 110). This may allow control circuitry 28 to characterize the wireless performance of each of the antennas within the BWP(s) assigned to UE device 10 (e.g., without needing to characterize the wireless performance of the antennas within other BWPs of the frequency band).

At operation 114, control circuitry 28 may select an antenna from the set of antennas for transmitting subsequent radio-frequency signals (e.g., for transmit diversity). Control circuitry 28 may select the antenna based on the wireless performance metric data gathered at operation 112. For example, control circuitry 28 may select the antenna 40 that produced the strongest wireless performance metric data for the BWP(s) assigned to UE device 10 for subsequent signal transmission. In this way, an optimal antenna for the assigned BWP(s) may be selected even if a different antenna would otherwise produce optimal wireless performance metric data when averaged over the entire bandwidth 88 of frequency band 80.

At operation 116, UE device 10 may use the selected antenna 40 to transmit radio-frequency signals using the assigned BWP(s) (e.g., using the BWP configuration received at operation 110). The selected antenna 40 may exhibit stronger wireless performance in the assigned BWP(s) than the antenna that exhibits stronger wireless performance when averaged across the entire bandwidth of frequency band 80. This may serve to optimize the wireless data transmission efficiency of UE device 10.

Processing may subsequently loop back to operation 110 via path 118 as the network switches the BWP(s) assigned to UE device 10. If desired, UE device 10 may continue to use the selected antenna 40 to transmit radio-frequency signals while processing the next iteration of operations 110-114 to ensure uninterrupted communications.

Consider an example in which the network signals a switch from a first BWP to a second BWP using RRC signaling. In this example, control circuitry 28 (e.g., the baseband circuitry of radio 44) may trigger an evaluation of each of the N antennas 40 in the second BWP immediately after receiving the corresponding message at operation 110. The control circuitry may measure reference signals within the bandwidth of the second BWP using each of the N antennas 40. The control circuitry may then select the best performing antenna in the second BWP from the N antennas 40 for subsequent signal transmission. This antenna may, for example, exhibit better SNR (or other wireless performance metric values) than the other antennas within the second BWP, even if the other antennas exhibit superior SNR within the first BWP or other BWPs of the frequency band.

In examples where the network signals the switch from the first BWP to the second BWP using DCI signaling, the control circuitry may gather wireless performance metric data using each of the N antennas and may select the best antenna for subsequent signal transmission for each assigned BWP no matter which BWP is currently active. When multiple BWPs are configured by the network, the control circuitry may measure reference signals within the bandwidth of each BWP using each of the antennas. If a DCI-based BWP switch is triggered, the control circuitry may then select the transmit antenna for the second BWP.

Due to hardware constraints, the same power amplifier and the same antenna is used for the PCC and the SCC (e.g., CC1 and CC2 of FIG. 4, respectively) when performing communications using intra-band contiguous CA. However, in practice, different antennas 40 may offer superior wireless performance for different component carriers (e.g., the PCC or SCC). UE device 10 may therefore select the best performing antenna 40 for the particular CC assigned to UE device 10 by the network while performing intra-band contiguous CA (e.g., UE device 10 may select an antenna 40 for transmit diversity based on the CC assigned to UE device 10 by the network).

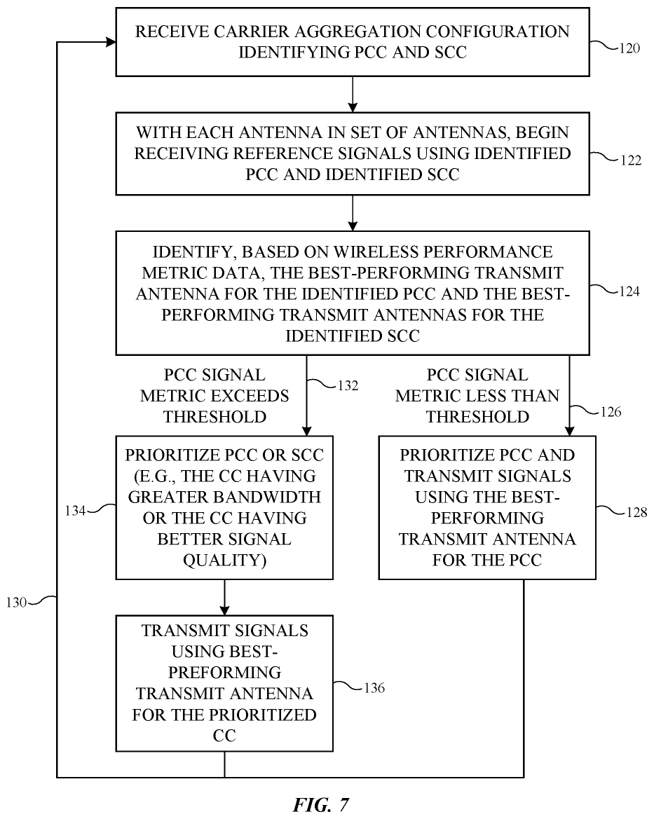

FIG. 7 is a flow chart of illustrative operations that may be performed by UE device 10 to select an antenna 40 for use in transmit diversity based on the CC assigned to UE device 10 by the network.

At operation 120, UE device 10 may receive a message from the network identifying a CA configuration for UE device 10 (e.g., a message instructing UE device 10 to perform intra-band contiguous CA). The CA configuration may specify (identify) a particular PCC (e.g., CC1 of FIG. 4 for communicating with base station 12A of FIG. 1) and an SCC (e.g., CC2 of FIG. 4 for communicating with base station 12B of FIG. 2) of the frequency band 80 that have been assigned to UE device 10 by the network.

At operation 122, UE device 10 may begin to receive (e.g., monitor for) reference signals transmitted by the network in the identified PCC and the identified SCC using each of its N antennas 40. The reference signals may include TRS, CSI-RS, SSB, or other reference signals. Control circuitry 28 may gather wireless performance metric data from the reference signals received in the identified PCC and the identified SCC.

At operation 124, control circuitry 28 may process the wireless performance metric data gathered at operation 122 to select (identify) a best performing antenna from the set of antennas in the PCC (e.g., the antenna that exhibited the strongest wireless performance metric data for signals received using the PCC) and to select (identify) a best performing antenna from the set of antennas in the SCC (e.g., the antenna that exhibited the strongest wireless performance metric data for signals received using the SCC). Even though two CCs are configured for UE device 10, only a single antenna 40 may be available for transmission at a given time due to the hardware constraints associated with intra-band contiguous CA. Control circuitry 28 may therefore need to decide which CC has priority for signal transmission.

If the reference signal received using the PCC produced wireless performance metric data (e.g., SNR, RSRP, etc.) that is less than a threshold value (e.g., if the PCC signal is weak), processing may proceed to operation 128 via path 126. At operation 128, control circuitry 28 may prioritize the PCC for signal transmission and may select the best performing antenna in the PCC (e.g., as identified at operation 82) for subsequent signal transmission. The best performing antenna in the PCC may then transmit radio-frequency signals in (using) the PCC. Processing may subsequently loop back to operation 120 via path 130 as the network updates the CA configuration for UE device 10.

If the reference signal received using the PCC produced wireless performance metric data that exceeds the threshold value, processing may proceed from operation 124 to operation 134 via path 132. At operation 134, control circuitry 28 may prioritize either the PCC or the SCC for subsequent signal transmission. As one example, control circuitry 28 may prioritize whichever of the PCC or the SCC has greater bandwidth. As another example, control circuitry 28 may prioritize whichever of the PCC or the SCC has higher signal quality (or smaller path loss). If desired, the control circuitry may apply hysteresis to avoid ping-pong switching in priority.

At operation 136, control circuitry 28 may select the best performing antenna of whichever of the PCC or the SCC was prioritized at operation 134 for subsequent signal transmission. For example, if the PCC is prioritized at operation 134, control circuitry 28 may select the antenna that produced the strongest wireless performance metric data in the PCC or, if the SCC is prioritized at operation 134, control circuitry 28 may select the antenna that produced the strongest wireless performance metric data in the SCC (e.g., as identified at operation 124). The selected antenna may then transmit radio-frequency signals using the prioritized component carrier (e.g., either the PCC or the SCC as prioritized at operation 134). Processing may subsequently loop back to operation 120 via path 130 as the network updates the CA configuration for UE device 10. In this way, the optimal antenna for the current CC assignment may be used at any given time, thereby optimizing transmit efficiency.

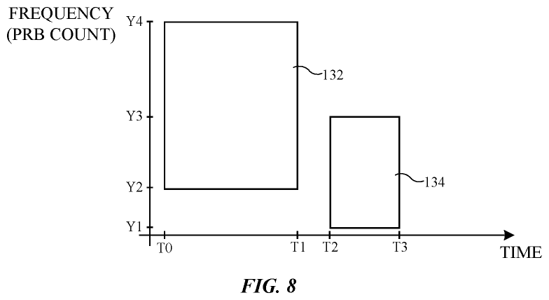

FIG. 8 is a diagram showing how the network may assign different frequency resources to UE device 10 at different times. As shown in FIG. 8, the network may assign frequency resources 132 for UE device 10 between times T0 and T1. Frequency resources 132 may include one or more PRBs 84 (FIG. 4) extending from frequency Y2 to frequency Y3. The network may then assign different frequency resources 134 for UE device 10 between times T2 and T3. Frequency resources 134 may include one or more PRBs 84 (FIG. 4) extending from frequency Y1 to frequency Y3. Frequency resources 132 and 134 may both be subsets of the bandwidth 88 of frequency band 80 (FIG. 4).

In implementations where UE device 10 selects a transmit antenna by averaging wireless performance metric data across the entire bandwidth 88 of frequency band 80, UE device 10 will use the same antenna 40 to transmit signals between times TO and Tl (using frequency resources 132) and to transmit signals between times T2 and T3 (using frequency resources 134). However, in practice, a first antenna 40 may exhibit superior wireless performance using the PRBs from frequency resources 132 whereas a second antenna 40 exhibits superior wireless performance using the PRBs from frequency resources 134. As such, UE device 10 may select an antenna 40 for transmit diversity based on the PRBs assigned to UE device 10 by the network.

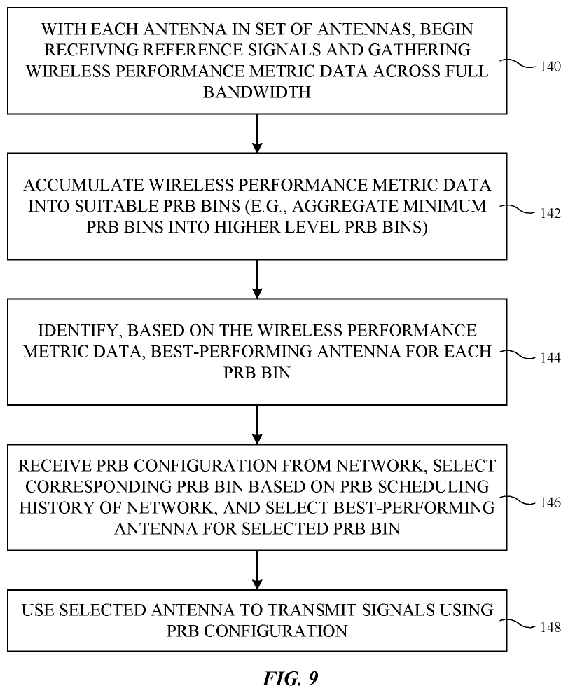

FIG. 9 is a flow chart of illustrative operations that may be performed by UE device 10 to select an antenna 40 for use in transmit diversity based on the PRBs assigned to UE device 10 by the network. UE device 10 may further optimize performance by utilizing wireless performance metric data binning and the PRB scheduling history of the network.

At operation 140, UE device 10 may begin to receive reference signals using each of its N antennas 40. Control circuitry 28 may gather wireless performance metric data across the full bandwidth 88 of frequency band 80.

At operation 142, control circuitry 28 may distribute the wireless performance metric data into PRB bins in frequency space (e.g., based on the frequency at which the wireless performance metric data was gathered). The bins may exist in multiple aggregation levels (e.g., in a data structure or memory on UE device 10), beginning with a minimum PRB bin size of one or a few contiguous PRBs at the lowest level up to a single PRB bin across all of bandwidth 88 at the highest level. Control circuitry 28 may store the binned wireless performance metric data for subsequent processing and may continue to add wireless performance metric data to the bins as the wireless performance metric data is gathered.

At operation 144, control circuitry 28 may identify the best performing antenna 40 for each bin (e.g., the antenna that exhibited the best wireless performance metric data when averaged over the frequency resources spanned by each bin).

At operation 146, UE device 10 may receive a PRB configuration from the network (e.g., a message identifying one or more PRBs assigned to UE device 10 for subsequent communications). Control circuitry 28 may select a corresponding one of the bins of wireless performance metric data based on the PRB scheduling history of the network. Control circuitry 28 may then select the best performing antenna for the selected bin (e.g., as identified at operation 144).

At operation 148, UE device 10 may use the selected antenna to transmit signals using the PRBs identified in the PRB configuration received from the network.

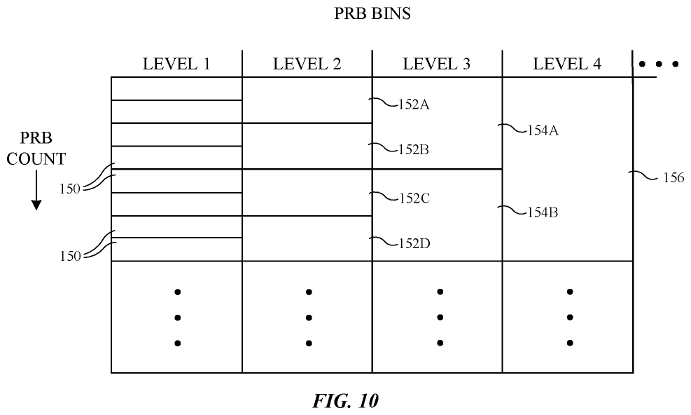

FIG. 10 is a diagram showing how control circuitry 28 may group wireless performance metric data into PRB bins while processing operation 142 of FIG. 9. As shown in FIG. 10, the wireless performance metric data may be grouped into at least four levels of bins. The lowest level bins 150 may each span one or a few PRBs. The second-lowest level bins 152 may each include a set (e.g., two) lowest level bins 150. The next level of bins 154 may each include a set (e.g., two) of bins 152 and the lower level bins contained therein (e.g., four bins 150). The next level of bins 156 may each include a set (e.g., two) of bins 154 and the lower level bins contained therein (e.g., four bins 152 and eight bins 150). The wireless performance metric data may be aggregated in this way up to a highest level bin spanning the entire bandwidth (e.g., the wireless performance metric data in each bin 152 may include the averaged wireless performance metric data from the lower level bins 150 of that bin 152, the wireless performance metric data in each bin 154 may include the averaged wireless performance metric data from the lower bins 152 included within that bin 154, etc.).

Each bin may store wireless performance metric data gathered within and averaged across its corresponding frequencies (at operations 140 and 142 of FIG. 9). Control circuitry 28 may process the wireless performance metric data in each bin to identify the best performing antenna from the set of N antennas 40 in UE device 10 for each bin (at operation 144 of FIG. 9). Different antennas may exhibit stronger wireless performance metric data depending on the level of aggregation. For example, antenna 40-1 (FIG. 3) may be the best performing antenna over the PRBs of bin 152A, antenna 40-2 may be the best performing antenna over the PRBs of bin 152B, antenna 40-3 may be the best performing antenna over the PRBs of bin 152C, antenna 40-1 may be the best performing antenna over the PRBs of bin 152D, antenna 40-1 may be the best performing antenna over the PRBs of bin 154A, antenna 40-2 may be the best performing antenna over the PRBs of bin 154B, antenna 40-1 may be the best performing antenna over the PRBs of bin 156, etc. The selection of PRB bin at operation 146 of FIG. 9 could therefore yield a different best performing antenna for subsequent signal transmission depending on which bin is selected.

As one example, control circuitry 28 may monitor the scheduling statistics of the network. The scheduling statistics may include information identifying which PRBs the network has assigned to UE device 10 in the past over a given period of time. As an example, control circuitry 28 may select higher level bins when the network allocates (or has a statistical history of allocating) larger bandwidths (e.g., greater numbers of PRBs) to UE device 10 and may select lower level bins when the network allocates (or has a statistical history of allocating) smaller bandwidths (e.g., lower numbers of PRBs) to UE device 10. For example, if the network usually allocates PRBs spanning the bandwidth of bins 154 of FIG. 10, control circuitry 28 may select a frequency bin 154 since the wireless performance metric data averaged over that wide of a span of frequencies should be processed to select the best performing transmit antenna. Control circuitry 28 may, for example, select frequency bin 154A if frequency bin 154A overlaps the assigned PRB configuration or overlaps the PRB configuration that has most often been assigned to UE device 10 by the network. Control circuitry 28 may then select the best performing antenna 40 of frequency bin 154A (e.g., the antenna 40 that produced the strongest wireless performance metric data within bin 154A) for subsequent signal transmission.

In other words, control circuitry 28 may determine or identify the recently scheduled bins for UE device 10 and may select an antenna 40 for signal transmission in real time based on the recently scheduled bins. For example, for a given evaluation period, control circuitry 28 may count the PRBs that have been scheduled to UE device 10 by the network. Control circuitry 28 may select the bin that matches the counted PRBs that were scheduled to UE device 10 over the evaluation period (e.g., where higher level bins match PRBs spanning wider frequencies and lower level bins match PRBs spanning lower frequencies). As an example, if the network schedules PRB numbers 1-10 during a first time slot, PRB numbers 10-15 during a second time slot, and PRB numbers 20-30 during a third time slot of an evaluation period, control circuitry 28 may select a bin that spans at least PRB numbers 1-30.

Control circuitry 28 may, for example, select the bin (from FIG. 10) that overlaps the greatest number of PRBs scheduled to UE device 10 over the evaluation period and the best performing antenna for that bin may perform subsequent signal transmission. As another example, control circuitry 28 may pass through the bins beginning with lowest level bins 150 and moving upwards in aggregation level. When the number of PRBs scheduled for UE device 10 exceeds a threshold value in a given bin, control circuitry 28 may select that bin and the best performing antenna from that bin may perform subsequent signal transmission.

In implementations where UE device 10 simply averages wireless performance metric data across the entire bandwidth 88 of frequency band 80 for selecting a transmit antenna, given constant channel/propagation conditions, the same transmit antenna 40 will be selected regardless of the range(s) of the PRB(s) scheduled for UE device 10 by the network. In addition, with varying signal strength of the SCC (while the PCC remains constant), the transmit antenna will remain constant. Further, when the network switches the PCC or SCC to a different BWP, the transmit antenna will remain constant. However, by processing the operations of FIGS. 6, 7, and 9, different transmit antennas 40 may be selected for signal transmission when different ranges of PRBs are scheduled for UE device 10 by the network (under constant channel/propagation conditions), when the network switches BWPs assigned to UE device 10, and/or when the network switches the CCs assigned to UE device 10. This may allow an optimal antenna 40 to be switched into use for transmission regardless of the subset of frequency resources in frequency band 80 scheduled by the network, thereby optimizing wireless performance for device 10.

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-10 may be performed by the components of UE device 10 using software, firmware, and/or hardware (e.g., dedicated circuitry or hardware). Software code for performing these operations may be stored on non-transitory computer readable storage media (e.g., tangible computer readable storage media) stored on one or more of the components of UE device 10 (e.g., storage circuitry 30 of FIG. 2). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of UE device 10 (e.g., processing circuitry 32 of FIG. 1, etc.). The processing circuitry may include microprocessors, central processing units (CPUs), application-specific integrated circuits with processing circuitry, or other processing circuitry.

The foregoing is merely illustrative and various modifications can be made to the described embodiments. The foregoing embodiments may be implemented individually or in any combination.

What is claimed is:

1. A method of operating an electronic device, the method comprising:
receiving, using a set of antennas, a reference signal in a frequency band;
receiving, from a wireless base station, a message identifying a subset of frequency resources of the frequency band; and
transmitting a radio-frequency signal using the subset of frequency resources identified by the message, the radio-frequency signal being transmitted by a transmit antenna from the set of antennas that is selected based on the subset of frequency resources identified by the message.

2. The method of claim 1, wherein the subset of frequency resources comprises a bandwidth part (BWP) of the frequency band and the transmit antenna is selected based on the BWP.

3. The method of claim 2, wherein the transmit antenna includes a first antenna from the set of antennas when the subset of frequency resources includes a first BWP of the frequency band and the transmit antenna includes a second antenna from the set of antennas when the subset of frequency resources includes a second BWP of the frequency band that is different from the first BWP.

4. The method of claim 2, further comprising:
with each antenna in the set of antennas, receiving the reference signal using the BWP, wherein the transmit antenna is selected based on wireless performance metric data generated from the reference signal received by each antenna in the set of antenna using the BWP.

5. The method of claim 1, wherein the subset of frequency resources comprises a component carrier (CC) of the frequency band and the transmit antenna is selected based on the CC.

6. The method of claim 5, wherein the transmit antenna includes a first antenna from the set of antennas when the subset of frequency resources includes a first CC of the frequency band and the transmit antenna includes a second antenna from the set of antennas when the subset of frequency resources includes a second CC of the frequency band that is different from the first CC.

7. The method of claim 5, further comprising:
with each antenna in the set of antennas, receiving the reference signal using the CC, wherein the transmit antenna is selected based on wireless performance metric data generated from the reference signal received by each antenna in the set of antennas using the CC.

8. The method of claim 1, wherein the subset of frequency resources comprises a set of physical resource blocks (PRBs) of the frequency band and the transmit antenna is selected based on the set of PRBs.

9. The method of claim 8, wherein the transmit antenna includes a first antenna from the set of antennas when the subset of frequency resources includes a first set of PRBs of the frequency band and the transmit antenna includes a second antenna from the set of antennas when the subset of frequency resources includes a second set of PRBs of the frequency band that is different from the first set of PRBs.

10. The method of claim 8, further comprising:
with each antenna in the set of antennas, receiving the reference signal across a bandwidth of the frequency band, wherein the transmit antenna is selected based on wireless performance metric data generated from the reference signal received by each antenna in the set of antennas across the bandwidth.

11. The method of claim 10, further comprising:
with one or more processors, aggregating the wireless performance metric data into hierarchical bins, wherein the transmit antenna is selected based on the hierarchical bins and a network scheduling history associated with the wireless base station.

12. A method of operating an electronic device, the method comprising:
receiving, at a receiver, a first message from a wireless base station identifying a first bandwidth part (BWP) configuration assigned to the electronic device; and
transmitting, with a first transmit antenna from the set of antennas, a first radio-frequency signal using the first BWP configuration, the first transmit antenna being selected from the set of antennas based on first wireless performance metric data generated from each antenna in the set of antennas using the first BWP configuration identified by the first message.

13. The method of claim 12, wherein the first message comprises a radio resource control (RRC) message.

14. The method of claim 12, wherein the first message comprises downlink channel information (DCI).

15. The method of claim 12, wherein the first transmit antenna comprises an antenna from the set of antennas having peak wireless performance metric data from the first wireless performance metric data gathered using the first BWP configuration.

16. The method of claim 12, further comprising:
receiving, at the receiver, a second message from the wireless base station identifying a switch from the first BWP configuration to a second BWP configuration;
generating, at one or more processors, second wireless performance metric data from each antenna in the set of antennas using the second BWP configuration identified by the second message; and
transmitting, with a second transmit antenna from the set of antennas that is different from the first set of antennas, a second radio-frequency signal using the second BWP configuration, the second transmit antenna being selected from the set of antennas based on the second wireless performance metric data.

17. An electronic device comprising:
one or more antennas configured to receive a message from a wireless base station identifying a primary component carrier (PCC) and a secondary component carrier (SCC) assigned to the electronic device;
one or more processors configured to
generate first wireless performance metric data from each antenna in the set of antennas using the PCC, and
generate second wireless performance metric data from each antenna in the set of antennas using the SCC; and
a transmitter configured to transmit a radio-frequency signal using a transmit antenna that is selected from the set of antennas based on the first wireless performance metric data and the second wireless performance metric data, the radio-frequency signal being transmitted using the PCC or the SCC.

18. The electronic device of claim 17, wherein the transmitter is configured to:
transmit the radio-frequency signal using the PCC when the first wireless performance metric data is below a threshold value; and
transmit the radio-frequency signal using the PCC or the SCC when the first wireless performance metric data is above the threshold value.

19. The electronic device of claim 18, wherein the transmitter is further configured, when the first wireless performance metric data is above the threshold value, to transmit the radio-frequency signal:
using the PCC when the PCC has greater bandwidth than the SCC, and
using the SCC when the SCC has greater bandwidth than the PCC.

20. The electronic device of claim 18, wherein the transmitter is further configured, when the first wireless performance metric data is above the threshold value, to transmit the radio-frequency signal:
using the PCC when the PCC exhibits higher signal quality than the SCC, and
using the SCC when the SCC exhibits higher signal quality than the PCC.
